(19) United States
(12) Patent Application Publication
(10) Pub. No.: US 2026/0203131 A1
(43) Pub. Date: Jul. 16, 2026

(54) PREDICTIVE PLACEMENT OF WORKLOADS WITHIN A WORKLOAD INFRASTRUCTURE

(71) Applicant: Dell Products L.P., Round Rock, TX (US)

(72) Inventors: ERIC RANDAL YOUNG, Alexandria, VA (US); TAMILARASAN JANAKIRAMAN, Cork (IE); CHARU LATA OJHA, Cork (IE)

(21) Appl. No.: 19/025,789

(22) Filed: Jan. 16, 2025

(51) Int. Cl. G06F 9/50

(52) U.S. Cl. CPC G06F 9/505; G06F 2209/5015; G06F 2209/5019

(57) ABSTRACT

Methods and systems for managing workload placement within a distributed system having a workload infrastructure with nodes that perform workloads are disclosed. The workloads and one or more node responsiveness metrics of the nodes may be used to select a node, from among the nodes, with the highest likelihood of performing the workload with a least amount of latency. The selected node may be one with a highest node responsiveness inference/score generated by a node responsiveness model configured to account for not only resource availability but also various responsiveness/latency metrics of each of the nodes.

### FIELD

Embodiments disclosed herein relate generally to memory device access control. More particularly, embodiments disclosed herein relate to systems and methods to manage access to one or more memory devices by abstracted resources hosted by a data processing system (e.g., a computing device).

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services. Users may input commands and interact with computing devices using HIDs.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIGS. 2A-2B show data interaction diagrams in accordance with one or more embodiments.

FIG. 2C shows a data flow diagram in accordance with one or more embodiments.

FIG. 3 shows a flowchart in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

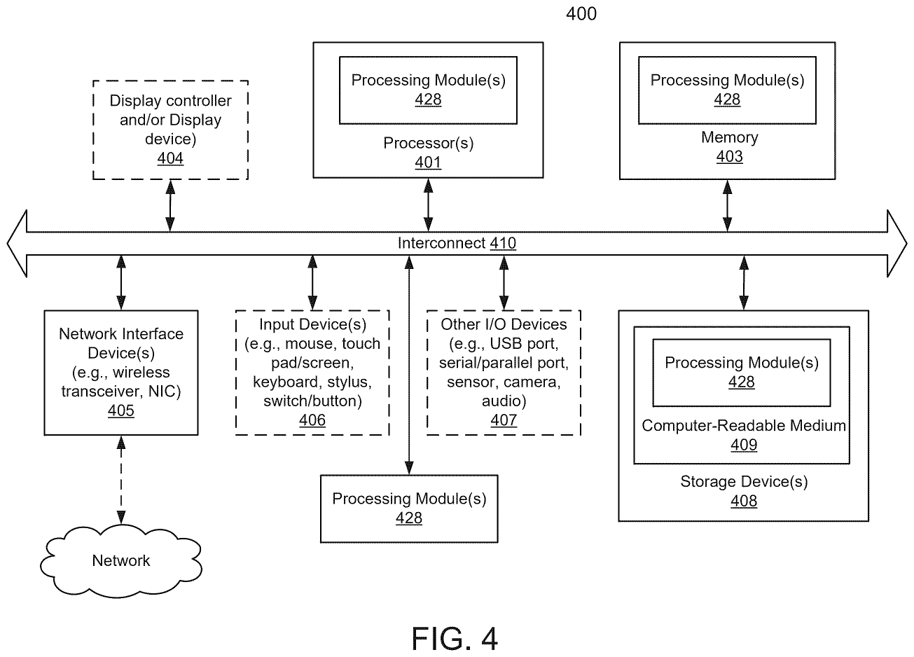

In general, embodiments disclosed herein relate to methods and systems for managing workload placement within a distributed system having a workload infrastructure with nodes that perform workloads (e.g., deployed containerized applications associated with application deployment, application updates and/or changes, application scaling, application monitoring, or the like). Each of the nodes of the workload infrastructure may be implemented using one or more data processing systems (e.g., computing devices, as described below in reference to FIG. 4).

Workload placement of workloads within a workload infrastructure is critical for maintaining high perform and efficient resource utilization (e.g., efficient use of the limited computing resources) of the data processing systems making up the workload infrastructure.

Workload placement is generally reactive, where resource usage thresholds (e.g., of the data processing systems making up a workload infrastructure) are considered and analyzed only after they have been breached, which causes not only unwanted delay of resource availability during workload spikes (e.g., delayed placement and start of workloads) and degraded performance issues (e.g., degraded computing functionality) of the data processing systems.

For example, a node may be assessed as being capable of hosting and executing a workload. However, such assessment may be limited and be based only on the node's resource availability at a certain point in time. Without considering other factors associated with workload placement and execution (e.g., delays in workload start times, network latency, etc.), a workload placed at this node that was initially expected to start at a certain point in time may not actually start at that time. Thus, issues such as degraded performance of the data processing systems (e.g., resource inefficiencies of the limited computing resources of each data processing system, increased likelihood of execution interruptions, or the like), delayed scaling of workloads, and increased latency are more likely to occur, particularly during high-demand periods of the workload infrastructure.

Additionally, after the workload is deployed to this node, unaccounted for and/or unexpected factors may cause the node to no longer have the resources to host and execute the workload and/or may cause the node to delay start of the workload, which will cause additional negative chain reactions with respect to existing and/or future planned for workloads on this node.

In view of the above known limitations of workload placements, embodiments herein provide a system and method for performing workload placement (and/or management) based on a predictive responsiveness model that considers real-time responsiveness of a node and/or cluster within a workload infrastructure. In particular, predictive responsiveness modeling may be used in conjunction with time-based forecasting to determine where workloads can be placed to be executed with a least amount of latency.

In embodiments, by continuously, for example, monitoring and analyzing one or more node responsiveness metrics such as container start times, scheduling delays, node response latency, and other related/similar factors (which will all be described below in more detail), a workload manager may intelligently assess how responsive a cluster and/or node will be to various workloads and advantageously make more sophisticated, data-driven workload placement decisions. As a result, embodiments herein not only ensures that resources (e.g., the limited computing resources of the data processing systems making up the workload infrastructure) are available but also ensures that the available resources are responsive by the time a node and/or cluster receives one or more workloads, even during high demand periods of the workload infrastructure.

By doing so, embodiments disclosed herein directly improve the overall functionalities of the data processing systems making up the workload infrastructure. In particular, by ensuring that these resources (e.g., the limited computing resources of the data processing systems making up the workload infrastructure) are both available and responsive, these resources may be used more efficiently and effectively in a way where less resources may be unintentionally tied up by unintended and/or unexpected delays and/or other issues. Thus, the resource use and allocation of the data processing systems may be improved, which directly improves the functionalities (e.g., computer functionalities) of these data processing systems (e.g., improved use of available storage and processing resources, or the like).

For example, embodiments disclosed herein may, for one, prevent the build-up of long workload queues within a node and/or cluster, which directly improves storage use and processing availability of the node and/or cluster. More specifically, more storage and processing resources may be allocated to perform other critical and/or essential processes (e.g., operating system (OS) related processes, processes associated with using applications already installed on the data processing system(s), or the like) besides the queuing and execution of the workloads.

Even more specifically, assume here that a node may also be used by a user at the workload infrastructure for processes (e.g., running applications, doing calculations, training machine learning models, or the like) that are not related to the workloads for which the node was sent, by ensuring that resources dedicated to executing the received workloads are more efficiently and effectively allocated, issues (e.g., delays, lag, longer processing times, data corruption, process/application crashes due to not enough resources being available, or the like) affecting these other non-related processes (e.g., other non-related computer implemented services provided by a node and/or cluster) may be prevented and/or eliminated.

Other advantages, improvements to workload management technology, and improvements to computer functionalities will be apparent below as more details regarding embodiment disclosed here are described.

In an embodiment, a method for managing workload placement within a distributed system comprising a workload infrastructure comprising nodes that perform workloads is provided. The method may include: obtaining a workload request for placement of a workload within the workload infrastructure, the workload being one of the workloads; selecting, using the workload and one or more node responsiveness metrics of the nodes, a first node of the nodes to place the workload, the first node being a node among the nodes with a highest likelihood of starting the workload with a least amount of latency; and based on the selecting, providing the workload to the first node for the first node to initialize performance of the workload.

The one or more node responsiveness metrics comprise, for each of the nodes, information indicative of workload start times, workload scheduling delays, and node response latency.

The first node is further selected based on the first node comprising computing resources compatible for performing the workload.

Each of the nodes comprises a workload management agent that also consumes limited computing resources of the respective node in which the workload management agent is instantiated, and the first node is further selected based on an amount of the limited computing resources consumed by the workload management agent.

The amount of the limited computing resources consumed by the workload management agent is based on at least a workload queue managed by the workload management agent and workload monitoring actions performed by the workload management agent.

Each of the nodes is assigned a node responsiveness score, the node responsiveness score being one of the one or more node responsiveness metrics, and the node responsiveness score being at least one metric used to generate a node responsiveness inference indicating that the first node being the node among that nodes with the highest likelihood of starting the workload with the least amount of latency.

The node responsiveness inference is generated by a node responsiveness model implemented using a machine learning based model trained to account for real-time and future node responsiveness of each of the nodes.

The node responsiveness model is trained using at least historical performance metrics and workload characteristics data of each of the nodes.

The method may further include: using the one or more node responsiveness metrics of the nodes to perform a workload placement/adjustment process to at least re-arrange existing workloads running within the workload infrastructure between the nodes and place new workloads to be performed by the nodes on nodes within the nodes with a fastest node ramp up speed from an idle state.

The workload placement/adjustment process is performed during off-peak hours of the workload infrastructure.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

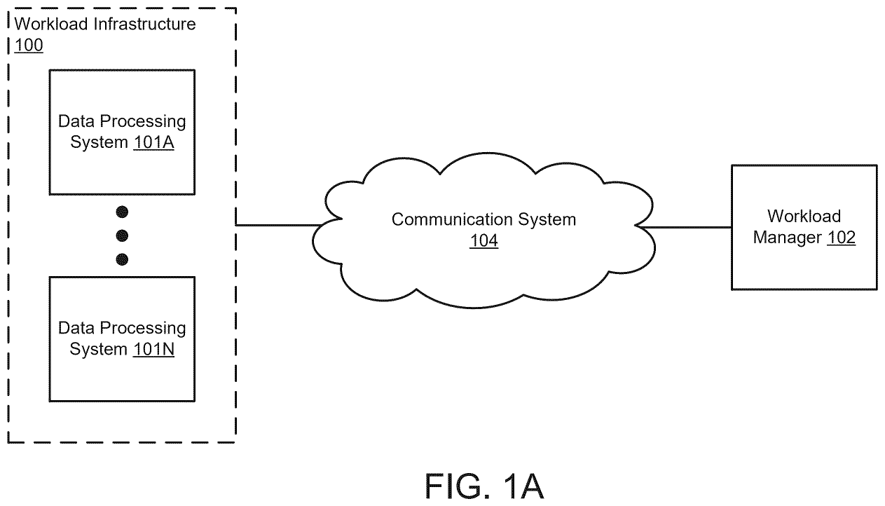

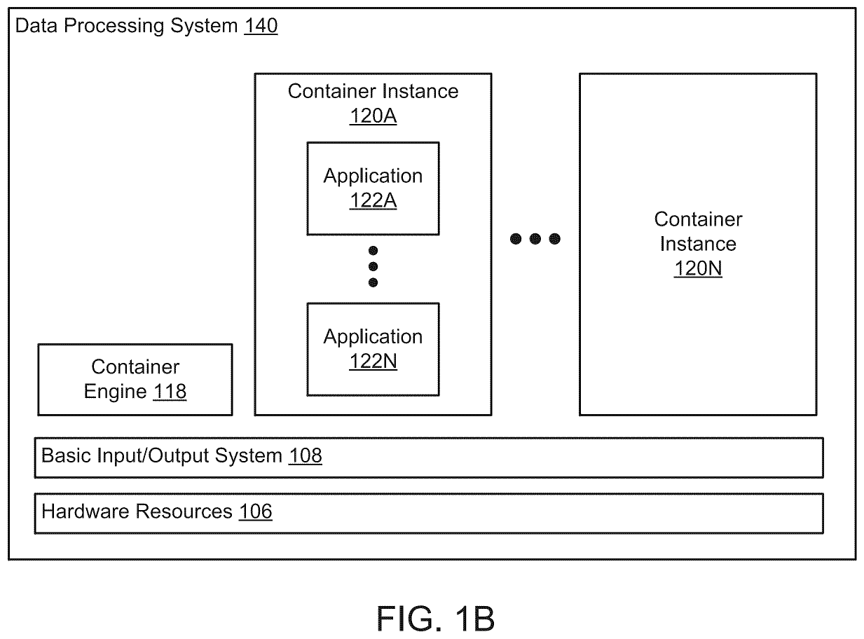

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, and/or any other type of service that may be implemented with a computing device.

To provide the above noted functionality, the system of FIG. 1A may include any number of data processing systems 101A-101N that make up a workload infrastructure 100. Workload infrastructure 100 may be any type of environment (e.g., a deployment, a remote server, a corporation's office, or the like) where the data processing systems 101A-101N may be hosted and used to provide computer implemented services to one or more users. In one example of embodiments disclosed herein, the workload infrastructure 100 may be configured as (and/or include) a Kubernetes environment/system.

Each data processing system 101A-101N may be a node within the workload infrastructure 100. One or more nodes may then be combined and/or arranged into one or more clusters, each of which having at least one of the nodes. Additionally, data processing systems 101A-101N may provide the computer implemented services to users of data processing systems 101A-101N and/or to other devices (not shown). Different data processing systems may provide similar and/or different computer implemented services.

To provide the computer implemented services, data processing systems 101A-101N may include various hardware components (e.g., processors, memory modules, storage devices, etc.) and host various software components (e.g., operating systems, application, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 101A-101N may host various services that provide the computer implemented service (e.g., application services) and/or that manage the operation of these services (e.g., management services). The aggregate (e.g., combination) of the management and application services may be a complete service that provide desired functionalities.

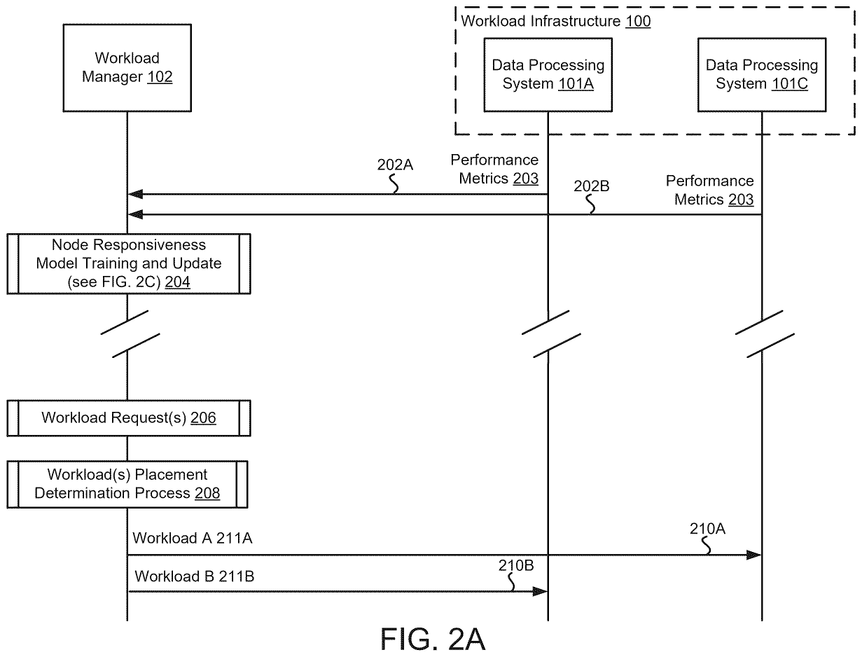

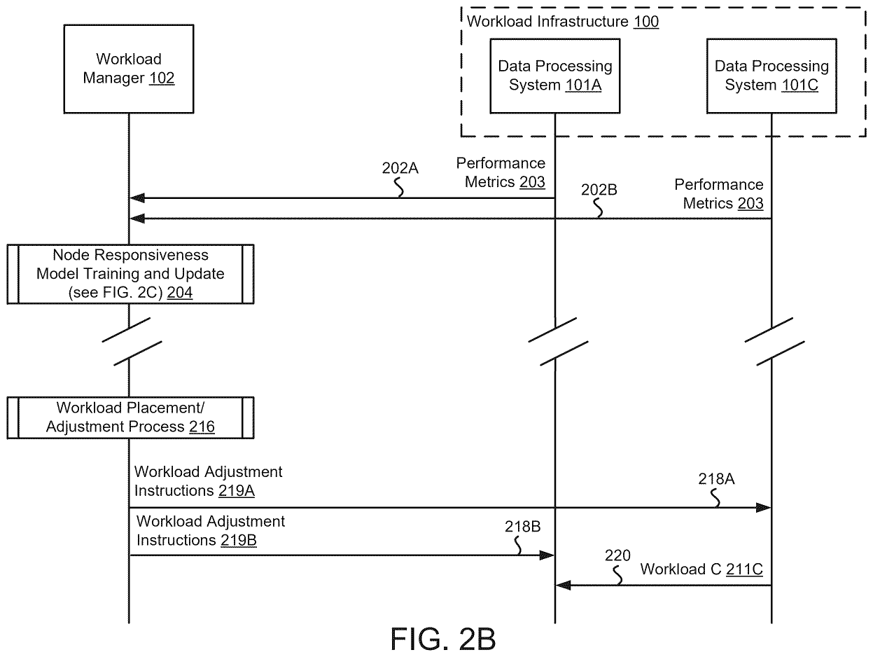

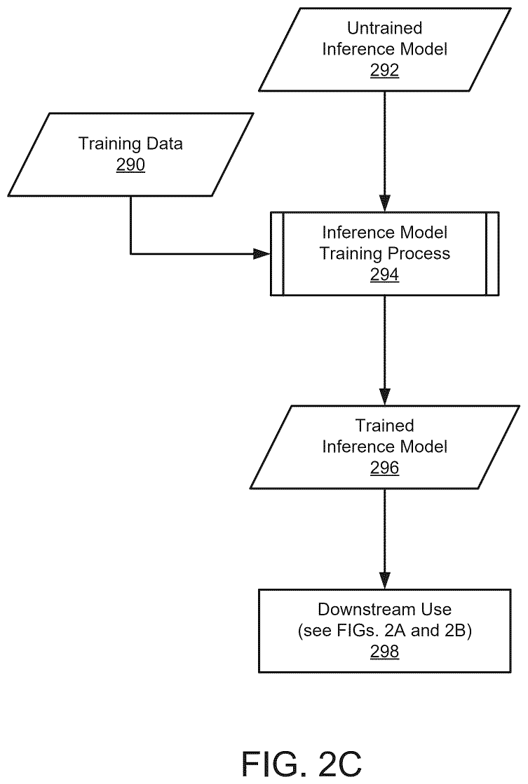

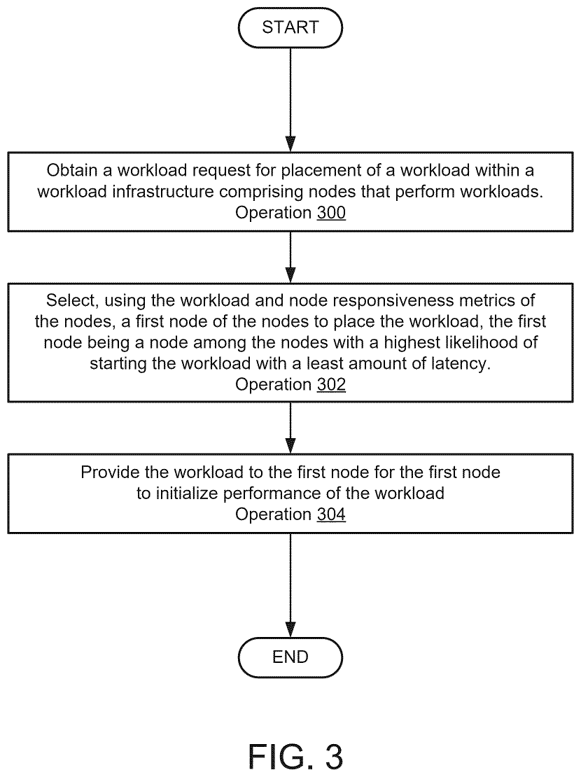

To manage the data processing systems 101A-101N and the services that these data processing systems 101A-101N provide, the system of FIG. 1A may include workload manager 102. Workload manager 102 may include various hardware components (e.g., processors, memory modules, storage devices, etc.) and host various software components (e.g., operating systems, application, startup managers such as basic input-output systems, etc.). These hardware and software components may provide the functionalities (e.g., the communication with and management of the data processing systems 101A-101N) of the workload manager 102 (e.g., functionalities associated with performance of the methods and processes discussed below in refernce to FIGS. 2A-3).

In one example, the workload manager 102 may be a computing device (e.g., computing device of FIG. 4) such as a desktop computer or server that is used by manufacturers (or distributors, administrators, etc.) of one or more components (e.g., hardware and software) installed within the data processing systems 101A-101N to communicate with and manage (namely, the hardware and/or software components installed within) the data processing systems 101A-101N. For example, the workload manager 102 may be configured to allocate, package, and transmit workloads (e.g., e.g., deployed containerized applications associated with application deployment, application updates and/or changes, application scaling, application monitoring, or the like) to one or more of the data processing systems 101A-101N.

Any of the components illustrated in FIG. 1A may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the Internet Protocol).

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 101A-101N shown in FIG. 1A.

To provide computer implemented services (e.g., the hosting and execution of one or more workloads received from the workload manager 102, or the like), data processing system 140 may include any quantity of hardware resources 106. Hardware resources 106 may include physical parts of data processing system 140 that store and run software. Hardware resources 106 may include processors, memory modules (also referred to herein as “memory devices”), storage devices, and/or other types of hardware components usable to provide computer implemented services. A basic input/output system (BIOS) 108 may be stored on the processors and memory modules.

BIOS 108 may be used to startup data processing system 140. On the startup, BIOS 108 may configure peripheral devices, such as a keyboard, mouse, monitor, etc. With the peripheral devices, BIOS 108 may configure hardware resources 106 for use by data processing system 140.

Container engine 118 (also referred to herein as “workload management agent”) may host and/or manage one or more container instances 120A-120N (e.g., workloads). For example, container engine 118 may manage a queue of workloads to be executed by data processing system 140 to instantiate (e.g., create) and/or manage a container instance (e.g., 120A) among the container instances 120A-120N. Container engine 118 may also gather performance-related and/or operational data from each of the container instances 120A-120N and relay such data to workload manager 102, which provides workload manager 102 with insights (e.g., information) as to what workloads are currently being executed by data processing system 140 and whether data processing system 140 can handle more workloads that workload manager 102 needs to assign.

Each container instance 120A-120N may run applications 122A-122N and/or any other processes (e.g., application installation and/or update files, or the like). Applications 122A-122N may be run on container instances 120A-120N separately from the operating system (OS) of the data processing system 140.

Running applications 112A-122N on container instances 120A-120N may require fewer computing resources (e.g., limited resources such as memory space and processing power, or the like, provided through the hardware resources 106) compared to running applications on, for example, virtual machines (VM) implemented using a hypervisor. Container instances 120A-120N may include only necessary libraries, binaries, dependencies, and applications 112A-122N without allocating the computing resources to a separate OS. Thus, container instances 120A-120N may startup faster and run more efficiently than other processes and/or systems such as VMs. Where computing resources are limited for applications 122A-122N, container instances 120A-120N may be ideal for running applications 122A-122N.

While FIG. 1B is illustrated as including a limited number of specific components, a data processing system in accordance with an embodiment may include fewer, additional, and/or different components than those illustrated therein. For example, in addition to all of the components shown in FIG. 1B, the data processing system 140 may also include part of all of the components of the example computing device described below in refernce to FIG. 4.

To further clarify embodiments disclosed herein, interaction diagrams in accordance with an embodiment are shown in FIGS. 2A-2B and a data flow diagram is shown in FIG. 2C. In the interaction diagrams of FIGS. 2A-2B, processes performed by and interactions between components of a system in accordance with an embodiment are shown. In the diagrams, components of the system are illustrated using a first set of shapes (e.g., 102, 100, 101A, 101C, etc.), located towards the top of each figure. Solid lines descend from this first set of shapes to indicate that the devices are operating during the corresponding period of time. Two diagonal lines may disconnect these solid lines and may be used to show that a certain amount of time has passed since a last-discussed process is performed by the components.

Processes performed by the components of the system are illustrated using a second set of shapes (e.g., 204, 206, 208, etc.) superimposed over these lines. Interactions (e.g., communication, data transmissions, etc.) between the components of the system are illustrated using a third set of shapes (e.g., 202A, 202B, 210A, 210B, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202A may occur prior to (or simultaneously with) the interaction labeled as 210A. However, it will be appreciated that the processes and interactions may be performed in different orders, any may be omitted, and other processes or interactions may be performed without departing from embodiments disclosed herein.

Starting with FIG. 2A, a first interaction diagram in accordance with an embodiment is shown. The first interaction diagram may illustrate processes and interactions that may occur during workload placement of workloads (e.g., by workload manager 102) on one or more data processing systems (e.g., 101A, 101C) of a workload infrastructure 100.

Details regarding the workload manager 102, workload infrastructure 100, and data processing systems 101A and 101C are discussed above in reference to FIGS. 1A-1B. Additionally, for ease of discussion, only two data processing systems 101A and 101C are shown in the interaction diagrams of FIGS. 2A-2B. However, one of ordinary skill would appreciate that the processes and methods discussed in the interaction diagrams of FIGS. 2A-2B may be implemented using any number of data processing systems (e.g., 101A-101N of FIG. 1A) organized in any combination of nodes and/or cluster arrangements.

At interactions 202A and 202B, data processing systems 101A and 101C may, respectively, provide performance metrics 203 to workload manager 102. In embodiments, the data processing systems 101A and 101C may be configured (e.g., by workload manager 102, by a user and/or administrator at workload infrastructure 100, or the like) to provide the performance metrics 203 at any specified interval of time (e.g., every 30 seconds, every minute, every hour, twice a day, four times a day, once a week, or the like). The performance metrics 203 may also be provided (e.g., via interactions 202A, 202B) in response to a direct request for these performance metrics 203 (e.g., a performance metric request) issued by the workload manager 102.

In embodiments, performance metrics 203 may include node responsiveness metrics of each of the data processing systems 101A and 101C (e.g., each of the nodes and/or clusters of nodes of the workload infrastructure 100). These node responsiveness metrics may be indicative of, for example: (i) container (e.g., workload) start times (e.g., by each node and/or cluster); (ii) workload scheduling and/or execution delays (e.g., by the container engine 118); (iii) workload response times; or the like.

More specifically, the performance metrics 230 may include, for example: (i) node/cluster performance metrics (per node) (also referred to herein as “historical performance metrics”); (ii) workload-specific data for each node and/or cluster; (iii) processes and resources being used by container engine 118 of each node (e.g., each data processing system 101A and 101C) to manager container instances 120A-120N running (e.g., executing) on each node; (iv) other, non-workload related processes being executed by each node (e.g., by each data processing system); or the like. In particular, because each container engine 118 of each data processing system 101A-101N (e.g., each workload management agent of each node) also consumes limited computing resources of their respective systems (e.g., for workload queuing, encryption and/or decryption of data associated with workloads, instantiating container instances 120A-120N, monitoring container instances 120A-120N and workloads, obtaining performance metrics from the workloads and/or container instances 120A-120N, and/or other similar/related processes pertaining to the management of the workloads received by the container engine 118), taking such processes and resources being used by container engine 118 of provides a more accurate insight (e.g., prediction, forecast, inference, or the like) into the responsiveness of a node (e.g., a particular data processing system) of the workload infrastructure 100. Similarly, information indicative of the other, non-workload related processes being executed by each node (e.g., by each data processing system) may be used similarly as the processes and resources being used by container engine 118 of each node to further enhance and improve upon the accuracy of the insight into the responsiveness of a node.

In embodiments, the node/cluster performance metrics (per node or cluster) may be collected and/or organized as time-series data within a time-series database maintained by workload manager 102. Such cluster performance metrics may include, for example: (i) a timestamp specifying a time (e.g., in a year-month-date-time format, or the like) at which the metrics were observed and/or obtained; (ii) a central processing unit (CPU) usage value (e.g., as a percentage (%), or the like) of each node; (iii) a memory usage value (e.g., in gigabytes (GB), or the like) of each node; (iv) a disk input/output value (e.g., in megabytes per second (MB/s), or the like) of each node; (v) a network latency (e.g., in milliseconds (ms), or the like); (vi) an assigned node responsiveness score (e.g., as a proxy label for training a node predictiveness model or as a previously generated node responsiveness inference, which is described in more detail below in reference to FIG. 2C); (vii) a node and/or cluster identification (ID) of the node and/or cluster (e.g., node 1, node 2, cluster A, cluster 4, or the like); or the like. An example of the node/cluster performance metrics (per node) organized in time-series data format is shown in Table 1 below.

TABLE 1
Example Node/Cluster Performance Metrics (per node)

| | | CPU | Memory | Disk | Network | Responsive- |
|---|---|---|---|---|---|---|
| | Node | Usage | Usage | I/O | Latency | ness |
| Timestamp | ID | (%) | (%) | (MB/s) | (ms) | Score |
| Nov. 11, 2024 | 1 | 70 | 32 | 110 | 15 | 0.9 |
| 00:00:00 | | | | | | |
| Nov. 11, 2024 | 1 | 65 | 30 | 120 | 12 | 0.92 |
| 00:01:00 | | | | | | |
| Nov. 11, 2024 | 1 | 72 | 33 | 110 | 13 | 0.88 |
| 00:02:00 | | | | | | |
| Nov. 11, 2024 | 2 | 60 | 28 | 95 | 16 | 0.85 |
| 00:00:00 | | | | | | |
| . . . | . . . | . . . | . . . | . . . | . . . | . . . |

In embodiments, the assigned node responsiveness score may be implemented in any format without departing from the scope of embodiments disclosed herein. For example, but not to limit embodiments disclosed herein, the responsive score may be a two decimal point number between 0.01 and 1 where a higher value (e.g., 0.9) indicates better (e.g., more, higher, or the like) responsiveness than a lower value (e.g., 0.05), or vice versa.

In embodiments, the workload-specific data collected as part of performance metrics 203 may include, but is not limited to: (i) workload type (e.g., CPU-bound, memory-bound workloads, or the like) being handled by each node and/or cluster; (ii) an average duration of workload(s) at a node and/or cluster; (iii) an average request and limit values for CPU and memory resources of a node and/or cluster; (iv) dependency information specifying dependency and/or affinity constraints of the workload(s) being executed by a node/cluster with respect to workloads on other nodes/clusters of the workload infrastructure 100; or the like.

Said another way, collection of the performance metrics 203 allow workload manager 102 to collect historical data on how quickly different node types and cluster configurations of the workload infrastructure 100 response to workload changes and use the collected historical data to create a database of responsiveness patterns for each node and/or cluster of the workload infrastructure 100.

In embodiments, the workload manager 102 may be configured to capture the performance metrics 203 from the nodes using a long short-term memory (LSTM) network. Other types of networks and/or protocols (e.g., application programming interface (API) calls, Hypertext Transfer Protocol (HTTP), or the like) may also be used to capture the performance metrics 203 without departing from the scope of embodiments disclosed herein.

Once workload manager 102 obtains (e.g., acquires, receives, or the like) the performance metrics 203 from the data processing systems 101A, 101C, the workload manager 102 ingests the performance metrics 203 into a node responsiveness model training and update process 204 to train one or more machine learning models (also referred to herein an a “node responsiveness model”) that are configured to forecast (e.g., generate an inference for) a responsiveness score for each node/cluster based on the performance metrics 203 (e.g., to account for real-time and future node responsiveness of each of the nodes). The responsiveness score generated by the node responsive model advantageously allows the workload manager 102 to predict a node/cluster's responsiveness under current and/or future load conditions of the workload infrastructure 100.

Turning now first to FIG. 2C, FIG. 2C shows a data flow diagram illustrating the node responsiveness model training and update process 204 of FIG. 2A (and FIG. 2B). In the data flow diagram of FIG. 2C, components and data (e.g., trained or untrained models, time-series data, or the like) are shown using a first set of shapes (e.g., 290, 292, 296, etc.), processes using the data and/or components are shown using a second set of shapes (e.g., 294, etc.), and uses of the data and/or components are shown using a third set of shapes (e.g., 298, etc.).

As shown in FIG. 2C, training data 290 and an untrained inference model 292 may be ingested into inference model training process 294 to obtain trained inference model 296.

In embodiments, the training data 290 may include any number (e.g., amount) of the performance metrics 230 discussed in above in reference to FIG. 2A. The training data 290 may also include any other information (e.g., operation patterns, other operation related data and metrics, or the like) associated with the data processing systems (e.g., 101A-101N) of workload infrastructure 100.

The untrained inference model 292 may be an untrained recurrent neural network (RNN) (or any other similar type of machine learning based models that are usable/trainable to generate inferences (e.g., predictions)). The untrained inference model 292 may be trained (e.g., using inference model training process 294 in conjunction with being trained on training data 290) to forecast (e.g., predict) a node's responsiveness under one or more types (e.g., present, future, or the like) load conditions of the node and/or or the workload infrastructure 100. Any types and/or processes related to training RNN models (or other similar types of models) may be performed during inference model training process 294 to train the untrained inference model 292 using the training data 290 (and/or other types of data).

Said another way, the trained inference model 296 (e.g., the node responsiveness model) may be tuned (e.g., trained) for responsiveness forecasting to predict which nodes are likely to respond promptly (e.g., with the least amount of latency) to workloads being placed on these nodes under current and/or future conditions.

For example, based on factors (e.g., latency metrics) such as container (workload) start times, workload scheduling delays, and workload response times, or the like that can be observed (e.g., derived) from the training data, the trained inference model 296 (e.g., the node responsiveness model) may forecast (e.g., predict) when a particular node/cluster, among the other nodes/clusters, will be able to actually commence execution of a workload placed (e.g., assigned) to the node either at a current or at a future point in time and assign a node responsiveness inference (e.g., in the same format as the node responsiveness score, or any other suitable format to indicate a degree of responsiveness of each node) indicative of such forecast/prediction.

Using data processing systems 101A, 101C shown in FIGS. 2A-2B as two example nodes/clusters, assume that only these two data processing systems 101A, 101C are being considered (e.g., evaluated) by the trained inference model 296 (e.g., the node responsiveness model) for placement of a workload. Further assume that both data processing systems 101A, 101C are compatible for executing the workload (e.g., have the necessary hardware and/or software requirements associated with the workload) and have available resources for executing the workload. However, based on the current performance metrics 230 of the data processing systems 101A, 101C (e.g., used as an input to the trained inference model 296 along with properties and/or characteristics of the workload), the trained inference model 296 may inference (e.g., predict) that data processing system 101A will more likely be able to respond to (e.g., start execution of, or the like) the workload faster than data processing system 101C because data processing system 101C, for example, may have exhibited previous patterns of consistent workload response delays due to issues such as network latency or other unexpected factors (e.g., a user running resource intensive processes beside the workload at random times during the day). The workload manager 102, having access to such an inference generated by the trained inference model 296, may then choose to assign the workload to data processing system 101A instead of data processing system 101C.

Using such responsiveness forecasting (e.g., by the trained inference model 296), embodiments disclosed herein may advantageously prioritize node assignment (e.g., for workload placement) based on responsiveness predictions to select nodes that can quickly meet workload demands, especially for latency-sensitive applications. This approach of embodiments disclosed herein also advantageously allows the workload manger 102 to dynamically adjust workload placements, even during unexpected workload spikes within the workload infrastructure 100, which directly results in improvements such as workload execution and completion latency reduction and performance maintenance in systems that implement such (or similar) workload management related technology.

Such processes of embodiments disclosed herein that consider not only resource availability but also the responsiveness of each node/cluster of the workload infrastructure also advantageously supplements existing auto-scaling capabilities of such/related workload management related technology with responsiveness insights to trigger proactive (rather than reactive) scaling actions before workload demands peak within a workload infrastructure 100, which advantageously ensures that resources (e.g., of the data processing systems 101A-101N making up the workload infrastructure) are not only available but also responsive to minimize delays in resource availability and ultimately improving not only end-user experience but also the computing functionalities of the data processing systems 101A-101N.

Embodiments disclosed herein are also advantageously more resilient to unexpected demand(s), reducing the need for manual intervention and ensuring smooth performance of workloads within the workload infrastructure 100 during peak and/or off-peak periods.

Once the trained inference model 296 is obtained, the trained inference model 296 may (as discussed above) be applied to one or more downstream uses (e.g., the node responsiveness inference discussed above). Such downstream uses are further discussed in FIGS. 2A and 2B.

Additionally, while the above description associates the node responsiveness model training and update process 204 as being performed by workload manager 102, embodiments disclosed herein are no limited to such a configuration/implementation.

For example, the training of the untrained inference model 292 may be performed by another computing device (e.g., a server or the like dedicated to only model training, or the like) that is separate and different from (and potentially remote to) workload manager 102. Once the trained inference model 296 is obtained by this separate computing device, the model may be deployed as a microservice or API that the workload manager 102 may call before scheduling one or more workloads to workload infrastructure 100.

As a non-limiting example, the trained inference model 296 may be wrapped in an API that the workload manager 102 may query for the node responsiveness inferences (e.g., for each node) generated by the trained inference model 296 (e.g., the node responsiveness model). Another non-limiting example, the workload manager 102 may be configured with a plugin, webhook, or the like that calls the API (in which the trained inference model 296 is wrapped) before placing a workload on a node of workload infrastructure 100. In this example, as part of the node responsiveness model training and update process 204, the workload manager 102 may only provide the separate computing device training the model with the performance metrics 230 and workload requirements without having to actually train/update the trained inference model itself. The separate computing device hosting the trained inference model 296 may then provide the workload manager 102 with a responsiveness prediction/inference for each node, which the workload manager 102 may use to select the best node (e.g., a node with the best/highest predicted responsiveness) to place a currently-being-scheduled workload.

In particular, turning back to FIG. 2A, the workload manager 102 may (e.g., concurrently with or after a certain amount of time has passed after the node responsiveness model training and update process 204) receive one or more workload requests 206. Each workload request 206 may include any amount of information (e.g., a container image, a workload description, a workload build file, or the like) associated with one or more workloads to be placed on the workload infrastructure 100.

Using the workload requests, the workload manager 102 may initialize (e.g., execute, perform, or the like) a workload placement determination process 208 using the node responsive model (e.g., the trained inference model 296 of FIG. 2C). In particular, the workload manager 102 may obtain, from the node responsive model, a responsiveness inference/prediction for each workload. The responsiveness inference/prediction for each workload may include responsiveness scores (and/or predictions) for each or a portion of nodes of the workload infrastructure 100 that indicate to the workload manager 102 a best node for handling the workload with the least amount of latency (e.g., the most responsive node for a workload).

For example, as shown in FIG. 2A, data processing system (e.g., node) 101C was determined to be the most responsive node for workload B 211B (that was included in at least one of the workload requests) while data processing system (e.g., node) 101A was determined to be the most responsive node for workload A 211A. Thus, at interactions 210A and 210B, the workload manager 102 respectively provides (e.g., places) workload A 211A and workload B 211B to respective ones of the data processing systems 101A and 101C. Using this approach, embodiments disclosed herein improve workload placement related technology by ensuring that a node/cluster selected to handle a particular workload can meet both resource and responsiveness requirements of the particular workload (even if the workload has to be performed (e.g., started) during non-peak/off-peak demand hours of the workload infrastructure 100).

Turning now to FIG. 2B, a second interaction diagram in accordance with an embodiment is shown. The second interaction diagram may illustrate processes and interactions that may occur during workload placement and/or adjustment of workloads (e.g., by workload manager 102) on one or more data processing systems (e.g., 101A, 101C) of a workload infrastructure 100 during off-peak/off-demand hours of the workload infrastructure 100.

In particular, similar to FIG. 2A, the workload manager 102 may perform node responsiveness model training and update process 204 after obtaining performance metrics 203 from the data processing systems 101A, 101C. More specifically, the node responsiveness model (e.g., the trained inference model 296 of FIG. 2C) may be configured to continue learning from off-peak patterns, which advantageously allows the node responsiveness model to fine-tune node responsiveness metrics (e.g., fine-tune the generated node responsiveness inference) for times of low activity and identifying nodes that can best handle background or period tasks during these off-peak/off-demand hours.

Additionally, learning from off-peak patterns further allows the node responsiveness model to improve the accuracy of the node responsiveness inference that it generates. In particular, off-peak hours are ideal for preemptive health and responsiveness checks on idle or lightly loaded nodes. Nodes may be pre-tested (e.g., by workload manager 102 using training and/or hypothetical workloads) for responsiveness during these off-peak hours to ensure that, when peak demand returns, the nodes can scale up seamlessly. The results of such off-peak hour responsiveness pre-test may be included in the performance metrics 203 received/obtained by the workload manager 102 during such off-peak hours.

Concurrently as or at a future point in time after performing the node responsiveness model training and update process 204, the workload manger 102 may use the node responsiveness model (e.g., the trained inference model 296 of FIG. 2C) to perform a workload placement/adjustment process 216.

As part of workload placement/adjustment process 216, workload manager 102 may utilize the node responsiveness model to assess responsiveness (e.g., node responsiveness) not only by raw capacity but also by a quickness with which each node can ramp up (e.g., from a lightly loaded or idle state during the off-peak/non-peak hours) if needed to perform (e.g., execute) a workload. For example, nodes with higher responsiveness inferences/scores may be chosen for lightweight or maintenance tasks, reserving highly capable nodes for anticipated future peaks, thereby advantageously reducing power and cooling costs of the data processing systems 101A-101N of workload infrastructure 100.

Additionally, during such off-peak/off-demand hours, the node responsive model may be additionally configured to identify underutilized nodes in order to allow workload manager 102 to advantageously consolidate workloads onto fewer nodes of the workload infrastructure 100, where the node responsiveness inference of these nodes indicate that these nodes can easily handle (e.g., can easily respond to with little to no latency) any transient spikes in demand associated with unexpected workloads or transition from off-peak to on-peak hours. Such consolidation further improves the workload infrastructure 100 by allowing free-up nodes (e.g., as a result of the consolidation) to enter low-power or maintenance states and/or be used by the users to provide other computer implemented services.

For example, as a result of one or more of the above-discussed processes associated with the workload placement/adjustment process 216, workload manager 102 may determine (e.g., using the node responsiveness model) that a workload C 211C currently placed on data processing system 101C can be re-allocated (e.g., re-arranged) to data processing system 101A (e.g., to consolidate workload C 211C with other workloads already on data processing system 101A, in response to determining that data processing system 101A is now the more responsive node compared to data processing system 101C during such off-peak hours (or even during regular/on-peak hours), or the like). As a result, at interactions 218A and 218B, workload manager 102 sends workload adjustments instructions 219A, 219B to respective ones of the data processing system 101A, 101C to cause data processing system 101C to move workload C 221C to data processing system 101A (e.g., at interaction 220 of FIG. 2B).

As discussed above, the components of FIGS. 1A-2C may perform various methods for managing workload placement of workloads within a workload infrastructure having nodes configured to host and perform (e.g., execute) the workloads. FIG. 3 illustrates an example of a method that may be performed by the components of FIGS. 1A-2C. For example, any of the data processing systems 101A-101N and/or the workload manager 102 may perform all or a portion of the methods. In the diagrams discussed below and shown in FIG. 3, any of the operations may be repeated, performed in different orders, and/or performed in parallel with or in a partially overlapping in time manner with other operations.

Starting at Operation 300 of FIG. 3, as discussed above in refernce to FIGS. 2A-2C, a workload request for placement of a workload within a workload infrastructure (e.g., 100 of FIG. 1A) comprising nodes configured to host and perform (e.g., execute) the workloads may be obtained.

In embodiments, the workload request may be obtained by workload manager (e.g., 102, FIG. 1A). The workload request may also be obtained by a container engine (e.g., 118, FIG. 1B) hosted by a data processing system (e.g., 140, FIG. 1B; any of 101A-101N of FIG. 1A).

At Operation 302, as discussed above in refernce to FIGS. 2A-2C, the workload and node responsiveness metrics of the nodes (e.g., each or a portion of the nodes) may be used to select a first node among the nodes to place the workload. In embodiments, the first node may be a node among the nodes with a highest likelihood of starting the workload with the least amount of latency (e.g., delay). Said another way, the first node may be a most responsive node among the nodes.

In embodiments, as part of selecting the first node, the workload manger 102 (and/or the container engine 118) may obtain node responsiveness inferences (e.g., from a trained node responsiveness model) for each of the nodes of the workload infrastructure. The first node may be a node, among the nodes, with a highest node responsiveness inference (e.g., a node responsiveness inference indicating that the first node will most likely be the most responsiveness node in terms of being able to host and execute the workload with the least amount of latency/delays in consideration of not only resource compatibility and availability but also other responsiveness metrics (e.g., network latency, workload completion and/or starting delays, unexpected workload causing delays, historic workload handling/management patterns, historic and/or current issues, or the like) of each of the nodes).

For example, assume that the first node is node A within a workload infrastructure contain nodes A, B, and C. Although nodes B and C may have more resource availability than node A, nodes B and C have been determined (e.g., by the node responsiveness model) to be less responsive in host, starting, and/or completing workloads than node A (e.g., due to various issues/factors (e.g., the responsiveness metrics, or the like) that may be unrelated or not fully related to resource availability. Said another way, even though nodes B and C have more resource availability than node A, nodes B and C have other issues that may cause these two nodes to not be able to respond (e.g., start and/or complete) the workload faster than node A. As a result, based on its responsiveness (e.g., based on node A being associated with a higher node responsiveness inference than nodes B and C), node A will be selected to handle the workload instead of nodes B and C.

At Operation 304, as discussed above in refernce to FIGS. 2A-2C, the workload associated with the workload request obtained at Operation 300 may be provided to the first node (e.g., along with instructions that would cause the first node to host and execute the workload) to initialize (e.g., cause) performance of the workload by the first node.

The process may end following operation 304.

Any of the components illustrated in FIGS. 1A-3 may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system-on-a-chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing workload placement within a distributed system comprising a workload infrastructure comprising nodes that perform workloads, the method comprising:
obtaining a workload request for placement of a workload within the workload infrastructure, the workload being one of the workloads;
selecting, using the workload and one or more node responsiveness metrics of the nodes, a first node of the nodes to place the workload, the first node being a node among the nodes with a highest likelihood of starting the workload with a least amount of latency; and
based on the selecting, providing the workload to the first node for the first node to initialize performance of the workload.

2. The method of claim 1, wherein the one or more node responsiveness metrics comprise, for each of the nodes, information indicative of workload start times, workload scheduling delays, and node response latency.

3. The method of claim 2, wherein the first node is further selected based on the first node comprising computing resources compatible for performing the workload.

4. The method of claim 2, wherein each of the nodes comprises a workload management agent that also consumes limited computing resources of the respective node in which the workload management agent is instantiated, and the first node is further selected based on an amount of the limited computing resources consumed by the workload management agent.

5. The method of claim 4, wherein the amount of the limited computing resources consumed by the workload management agent is based on at least a workload queue managed by the workload management agent and workload monitoring actions performed by the workload management agent.

6. The method of claim 2, wherein each of the nodes is assigned a node responsiveness score, the node responsiveness score being one of the one or more node responsiveness metrics, and the node responsiveness score being at least one metric used to generate a node responsiveness inference indicating that the first node being the node among that nodes with the highest likelihood of starting the workload with the least amount of latency.

7. The method of claim 6, wherein the node responsiveness inference is generated by a node responsiveness model implemented using a machine learning based model trained to account for real-time and future node responsiveness of each of the nodes.

8. The method of claim 7, wherein the node responsiveness model is trained using at least historical performance metrics and workload characteristics data of each of the nodes.

9. The method of claim 1, further comprising:
using the one or more node responsiveness metrics of the nodes to perform a workload placement/adjustment process to at least re-arrange existing workloads running within the workload infrastructure between the nodes and place new workloads to be performed by the nodes on nodes within the nodes with a fastest node ramp up speed from an idle state.

10. The method of claim 9, wherein the workload placement/adjustment process is performed during off-peak hours of the workload infrastructure.

11. A non-transitory machine-readable medium having instructions stored therein, which when executed by a processor, cause the processor to perform operations for managing workload placement within a distributed system comprising a workload infrastructure comprising nodes that perform workloads, the operations comprising:
obtaining a workload request for placement of a workload within the workload infrastructure, the workload being one of the workloads;
selecting, using the workload and one or more node responsiveness metrics of the nodes, a first node of the nodes to place the workload, the first node being a node among the nodes with a highest likelihood of starting the workload with a least amount of latency; and
based on the selecting, providing the workload to the first node for the first node to initialize performance of the workload.

12. The non-transitory machine-readable medium of claim 11, wherein the one or more node responsiveness metrics comprise, for each of the nodes, information indicative of workload start times, workload scheduling delays, and node response latency.

13. The non-transitory machine-readable medium of claim 12, wherein the first node is further selected based on the first node comprising computing resources compatible for performing the workload.

14. The non-transitory machine-readable medium of claim 12, wherein each of the nodes comprises a workload management agent that also consumes limited computing resources of the respective node in which the workload management agent is instantiated, and the first node is further selected based on an amount of the limited computing resources consumed by the workload management agent.

15. The non-transitory machine-readable medium of claim 14, wherein the amount of the limited computing resources consumed by the workload management agent is based on at least a workload queue managed by the workload management agent and workload monitoring actions performed by the workload management agent.

16. A data processing system, comprising:
a processor; and
a memory coupled to the processor to store instructions, which when executed by the processor, cause the processor to perform operations for managing workload placement within a distributed system comprising a workload infrastructure comprising nodes that perform workloads, the operations comprising:
obtaining a workload request for placement of a workload within the workload infrastructure, the workload being one of the workloads;
selecting, using the workload and one or more node responsiveness metrics of the nodes, a first node of the nodes to place the workload, the first node being a node among the nodes with a highest likelihood of starting the workload with a least amount of latency; and
based on the selecting, providing the workload to the first node for the first node to initialize performance of the workload.

17. The data processing system of claim 16, wherein the one or more node responsiveness metrics comprise, for each of the nodes, information indicative of workload start times, workload scheduling delays, and node response latency.

18. The data processing system of claim 17, wherein the first node is further selected based on the first node comprising computing resources compatible for performing the workload.

19. The data processing system of claim 17, wherein each of the nodes comprises a workload management agent that also consumes limited computing resources of the respective node in which the workload management agent is instantiated, and the first node is further selected based on an amount of the limited computing resources consumed by the workload management agent.

20. The data processing system of claim 19, wherein the amount of the limited computing resources consumed by the workload management agent is based on at least a workload queue managed by the workload management agent and workload monitoring actions performed by the workload management agent.
